(19) United States
(12) Patent Application Publication
(10) Pub. No.: US 2007/0272899 A1
(43) Pub. Date: Nov. 29, 2007

(54) Fluorescent powder for blue-light emitting diodes

(75) Inventor: Soshchin Naum, Changhua City (TW)

Correspondence Address: John G. Chupa;Law Offices of John Chupa & Associates, P.C., Suite 50, 28535 Orchard Lake Road, Farmington Hills, MI, 48334, US

(73) Assignee: Shian-Meng Chen Tsai

(21) Appl. No.: 11/701,637

(22) Filed: Feb. 2, 2007

(30) Foreign Application Priority Data
May 26, 2006 (TW) 095118800

(51) Int. Cl. C09K 11/08; C09K 11/77

(52) U.S. Cl. 252/301.4 R

(57) ABSTRACT

The present invention discloses a fluorescent powder for blue-light emitting diode based on a garnet-structure yttrium and gallium compound with a chemical formula of (Y,Gd)₃Al₅₋ₓ(Mg,Si)ₓO₁₂(x=0˜3) wherein the ratio of Y and Gd ions is changed with the shifting peak value of excited Ce⁺³ and/or Cr⁺³ radiations.

### BACKGROUND OF THE INVENTION

1. Field of the Invention

The invention relates to a fluorescent powder for blue-light emitting diodes and in particular to a fluorescent powder for blue-light emitting diodes which can be used as a coating for the re-emitting surface of solid-state light sources and which can generate a different state of radiation light compared with that generated by blue solid-state light sources.

2. Description of the Related Art

The light source under development, especially the white light, is a mixture of lights of several colors. Visible white light consists of at least two lights of different wavelengths. When human eyes receive red, blue, and green lights, or complementary lights such as blue and yellow lights at the same time, white light will be seen. Consequently, light of different colors can be generated.

In the prior art of white solid-state lighting, the complementary lights approach is generally adopted:
Solid-state lighting sources made of InGaAlP, GaN, and GaP are connected and controlled by electric current, respectively, to emit red, green, and blue lights, which are then mixed through lens to generate white light.
Solid-state lighting sources made of GaN, and GaP are connected and controlled by electric current to emit blue and yellow-green lights, respectively, which are then mixed through lens to generate white light.

However, the two said methods in practice have disadvantages remained to be improved. For example, if one of the solid-state lights failed, a white light cannot be obtained; also, since these light sources have different positive bias voltages, a multiple of control circuits are required, leading to a higher cost.
In 1996 Nichia Chemical in Japan developed a white LED by mixing the blue light of indium gallium nitride and the yellow light of cerium-doped yttrium aluminum garnet, two complementary colors, to produce white light. However the spectrum continuity of such a white light is not comparable to that of the sun light and thus it can only be as lighting.
The Japan Sumitomo Electric Industries, Ltd also invented a LED using ZnSe, in which complementary colors were also used to produce white light.

Compared with the aforementioned prior arts in the field of white-light LED, the present invention uses unique inorganic fluorescent powder with a blue-light solid-state light source to produce diverse radiation lights.

### SUMMARY OF THE INVENTION

The primary objective of the present invention is to produce an inorganic fluorescent powder with strong light-emitting capability to be used as short-wavelength solid-state light sources.

Another objective of the present invention is to produce an inorganic fluorescent powder capable of emitting lights covering half visible light spectrum of blue, green, yellow, and orange.

Yet another objective of the present invention is to provide a formula of inorganic fluorescent powder synthesized by regeneration technology and the formula used requires no expensive chemical reagents in order to cut down cost.

Still yet another objective of the present invention is to provide a fluorescent powder for blue-light emitted diode based on a garnet-structure yttrium gadolinium with a chemical formula of (Y,Gd)₃Al₅₋ₓ(Mg,Si)ₓO₁₂ (x=0˜3), wherein the ratio of yttrium to gadolinium varies with the shifting peak values of the excited Ce⁺³ and Cr⁺³ radiations.

### DETAILED DESCRIPTION OF THE INVENTION

The present invention is to disclose a fluorescent powder for blue-light emitting diodes, which is, for example but not limited to, an inorganic fluorescent powder based on garnet-structure yttrium gadolinium with a chemical formula of (Y,Gd)₃Al₅₋ₓ(Mg,Si)ₓO₁₂ (x=0˜3), wherein the ratio of yttrium to gadolinium varies to ensure the shifting peak values of the excited Ce⁺³ and Cr⁺³ radiations.

The said fluorescent powder is based on, for example but not limited to, a garnet-structure yttrium gallium with a chemical formula as (Y,Gd)₃Al₅₋ₓ(Mg,Si)ₓO₁₂ (x=0˜3). Ce⁺³ used as an exciter to be excited by blue and blue-green visible lights of wavelength 400-500 nm to re-radiate a wideband radiation of half-width Δλ_{0,5}>110 nm and/or narrowband radiation of half-width Δλ=20˜40 nm with the radiation peak shifting to 535˜550 nm.

The ratio of Y and Gd ions of the said fluorescent powder ranges from 2.8:0.2 to 1:2, increasing as the peak value of the excited Ce⁺³ radiation. The optimum concentration of Yttrium and Gallium is 0.005-0.05%, wherein the mole ratio of magnesium oxide and silica oxide in Yttrium Gallium garnet is MgO:SiO₂=1±0.02 to ensure the peak radiation value shifting 20-40 nm toward longer wavelength.

First, the reason of choosing the fluorescent powder with garnet cubic structure is that the structure has a good compatibility with the d-d electron active centers such as Ce⁺³. In the experiment for the present invention, the best light intensity can be emitted when the garnet-structured fluorescent powder was excited by Ce⁺³. Second, the said chemical compositions of the compound allow two methods to shift the peak value of emitted lights toward longer wavelength. The first method is to partially replace Y ion with Gd ion, shifting the Ce⁺³ radiation toward higher wavelength by 535-590 nm. The second method is to partially replace the Al⁺³ ions with a pair of ions, Mg⁺² and Si⁺⁴ for example, in the anion lattice.

In the first said method, the excited radiation spectrum is gradually and slowly shifting toward longer wavelength by 1 nm per 1% Gd ion replaced by 1% Y ion.

In the second said method, two Al⁺³ are replaced by a pair of Mg⁺² and Si⁺⁴, yielding a sudden change in the excited Ce⁺³ radiation wavelength by 35 nm. The difference between the two methods of shifting lower toward higher wavelength is resulted from the difference in the coordination numbers of replaced ions. The coordination number of Gd ion is 8-12, while that of Al ion is 4-6. An ion with larger coordination number will experience slower change in its surrounding ions. When Al ion having smaller coordination number in the garnet-structured fluorescent powder is replaced with doped Mg⁺² and Si⁺⁴, a sudden change in the force field of the lattice will be resulted.

The fluorescent powder for blue-light emitted diode according to the present invention is characterized in using the garnet-structure yttrium gadolinium as its base with the ratio of Y and Gd ions ranging from 2.8:0.2 to 1:2, which in changed with the shifting peak value of excited Ce⁺³ and/or Cr⁺³, wherein the optimum concentration of Yttrium and Gallium is 0.005˜0.05%.

Also, the concentrations of Mg⁺² and Si⁺⁴ in the present fluorescent powder can be adjusted by changing the chemical compositions as below:
(Y,Gd)₃Al₅O₁₂:Ce,Cr
(Y,Gd)₃Al_{4,5}Mg_{0.25}Si_{0.25}O₁₂: Ce,Cr
(Y,Gd)₃Al₄Mg_{0.5}Si_{0.5}O₁₂: Ce,Cr
(Y,Gd)₃Al_{3.5}Mg_{0.75}Si_{0.75}O₁₂: Ce,Cr
(Y,Gd)₃Al_{3.0}Mg_{1,0}Si_{1.0}O₁₂: Ce,Cr
(Y,Gd)₃Al_{2.0}Mg_{1.5}Si_{1.5}O₁₂: Ce,Cr

Compared with the same valence replacement between Y and GD, the replacement of Al⁺³ with Mg⁺² and Si⁺⁴ is different in valence, wherein Mg⁺² replacing Al⁺³ will form a (MgAl)′ center with a negative charge equivalent to the positive charge of the (SiAl)• center formed by the replacement of Al⁺³ with Si⁺⁴, i.e. (MgAl)′=(SiAl)• This condition demands the equality between Mg and Si atoms in the garnet crystal.

Furthermore, it was discovered experimentally that when the difference between Mg or Si atoms and the other element, Si or Mg, respectively, doesn't excess ±0.02, the peak in the radiation spectrum will shift 20-40 nm toward longer wavelength. The fluorescent powder designed according to the experimental findings is characterized in that the molar mass between the magnesium oxide and silica oxide is MgO:SiO₂=1±0.02, and thus the peak in the radiation spectrum will shift 20-40 nm toward longer wavelength.

The fluorescent powder of garnet-structure yttrium gadolinium doped with Al and Si-doped according to the present invention can be produced in industrial class solid-state synthesizing method under high temperature, weak reduction environment with yttrium oxide (purity=99.99%), gadolinium oxide, magnesium oxide, silica, aluminum oxide (99.95%), cerium oxide, and chromium oxide (99.9%).

For two methods of replacing ions described above, Y [symbol] Gd and Al [symbol] Mg+Si, in the garnet structure, there is no loss of photon radiated by the fluorescent powder. From the absorbent spectrum, it is clear that all the said materials can well absorb the radiation of the visible light spectrum since the mixed powder shows yellow and orange colors.

The fluorescent powder for blue-light emitted diode according to the present invention is based on a garnet-structure Yttrium Gadolinium with the ratio of yttrium to gadolinium being Y:Gd=2.8:0.2˜1:2, which is changed with the shifting peak value of emitted Ce⁺³ and/or Cr⁺³ radiation. Thus, it can overcome the shortcomings of the prior art of fluorescent powder for blue-light emitted diodes.

While the invention has been described by way of example and in term of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A fluorescent powder for blue-light emitting diode based on a garnet-structure yttrium and gallium compound with a chemical formula of (Y,Gd)₃Al₅₋ₓ(Mg,Si)ₓO₁₂(x=0˜3) wherein the ratio of Y and Gd ions is changed with the shifting peak value of excited Ce⁺³ and/or Cr⁺³ radiations.

2. The fluorescent powder as defined in claim 1, wherein said the ratio of Y and Gd ranges from 2.8:0.2 to 1:2.

3. The fluorescent powder as defined in claim 2, wherein a garnet-structure yttrium gallium with a chemical formula as (Y,Gd)₃Al₅₋ₓ(Mg,Si)ₓO₁₂ (x=0˜3) and Ce⁺³ used as an exciter to be excited and excited by blue and blue-green visible lights of wavelength 400-500 nm to re-radiate a wideband radiation of half-width Δλ_{0,5}>110 nm and/or narrowband radiation of half-width Δλ=20˜40 nm with the radiation peak shifting to 535˜550 nm.

4. The fluorescent powder as defined in claim 3, in which the concentration of yttrium and gallium is 0.005-0.05%.

5. The fluorescent powder as defined in claim 1, wherein the garnet-structure yttrium gallium further contains magnesium oxide and silica with the mole ratio of MgO:SiO₂=1±0.02.

6. The fluorescent powder as defined in claim 5, wherein the peak value of the excited radiation of the fluorescent powder shifts 20-40 nm toward longer wavelength.

7. The fluorescent powder as defined in claim 6, wherein the Y ion is partially replaced by Gd ion and the excited radiation shifts toward longer wavelength to 535-590 nm.

8. The fluorescent powder as defined in claim 7, wherein the excited radiation spectrum is gradually and slowly shifting toward longer wavelength by 1 nm per 1% Gd ion replaced by 1% Y ion.

9. The fluorescent powder as defined in claim 6, wherein a pair of Al⁺³ are replaced by a Mg⁺² and a Si⁺⁴, yielding a sudden change in the Ce⁺³ excited radiation wavelength by 35 nm for every pair of Al⁺³ replaced with a Mg⁺² and a Si⁺⁴.

10. The fluorescent powder as defined in claim 1, wherein the concentration of Mg⁺² and Si⁺⁴ can be changed according to the chemical formula (Y,Gd)₃Al₅O₁₂:Ce,Cr.

11. The fluorescent powder as defined in claim 1, wherein the concentrations of Mg⁺² and Si⁺⁴ vary according to (Y,Gd)₃Al_{4.5}Mg_{0.25}Si_{0.25}O₁₂:Ce,Cr.

12. The fluorescent powder as defined in claim 1, wherein the concentrations of Mg⁺² and Si⁺⁴ can be changed according to the chemical formula (Y,Gd)₃Al_{2.0}Mg_{0.5}Si_{0.5}O₁₂:Ce,Cr.

13. The fluorescent powder as defined in claim 1, wherein the concentrations of Mg⁺² and Si⁺⁴ can be changed according to the chemical formula (Y,Gd)₃Al_{3.5}Mg_{0.75}Si_{0.75}O₁₂:Ce,Cr.

14. The fluorescent powder as defined in claim 1, wherein the concentrations of Mg⁺² and Si⁺⁴ can be changed according to the chemical formula (Y,Gd)₃Al_{3.0}Mg_{1.0}Si_{1.0}O₁₂:Ce,Cr.

15. The fluorescent powder as defined in claim 1, wherein the concentrations of Mg⁺² and Si⁺⁴ can be changed according to the chemical formula (Y,Gd)₃ μM_{2.0}Mg_{1,5}Si₅O₁₂:Ce,Cr.
